(19) United States
(12) Patent Application Publication
(10) Pub. No.: US 2014/0208337 A1
(43) Pub. Date: Jul. 24, 2014

(54) MEDIUM PROCESSING DEVICE, CONFIGURATION INFORMATION SETTING METHOD, AND COMPUTER-READABLE RECORDING MEDIUM HAVING STORED THEREIN CONFIGURATION INFORMATION SETTING PROGRAM

(71) Applicant: FUJITSU LIMITED, Kawasaki-shi (JP)

(72) Inventor: Eiji TSUKADA, Kawasaki (JP)

(73) Assignee: FUJITSU LIMITED, Kawasaki-shi (JP)

(21) Appl. No.: 14/225,185

(22) Filed: Mar. 25, 2014

Related U.S. Application Data
(63) Continuation of application No. PCT/JP2011/073665, filed on Oct. 14, 2011.

(51) Int. Cl. G11B 19/10

(52) U.S. Cl. CPC G11B 19/10
USPC 720/626

(57) ABSTRACT

A medium processing device includes a processor, the processor emits light to a medium by a light source and calculates spherical aberration information relevant to spherical aberration related to the medium based on a detection result of reflected light, determines an installation direction of the medium processing device based on the spherical aberration information, and sets configuration information relevant to an operation for the medium based on a determination result.

### CROSS-REFERENCE TO RELATED APPLICATION

This application is a continuation application of International Application PCT/JP2011/073665 filed on Oct. 14, 2011 and designated the U.S., the entire contents of which are incorporated herein by reference.

### FIELD

The present invention relates to a medium processing device, a method of setting configuration information in a medium processing device, and a computer-readable recording medium having stored therein a configuration information setting program.

### BACKGROUND

In recent years, an information processing apparatus, such as a personal computer (PC) or a server, including an optical disk device (medium processing device), which performs processing for an optical disk (medium), such as a CD-ROM or a DVD-ROM, has been mainly used.

There are various types of information processing apparatuses, such as laptop or desktop information processing apparatuses. The optical disk device is installed (mounted) in the information processing apparatus in various directions, such as a lateral direction and a longitudinal direction, depending on the shape of the information processing apparatus.

FIG. 9 is a diagram illustrating an example of the structure of an optical disk device 300 which is installed in the information processing apparatus.

As illustrated in FIG. 9, the optical disk device 300 includes an optical pickup unit (hereinafter, referred to as an OPU) 330 which reads data from an inserted optical disk 600. In addition, the optical disk device 300 includes a controller 340 which performs focus servo control for adjusting the focus of the OPU 330 on the surface of the optical disk 600 (hereinafter, simply referred to as a disk surface) or tracking servo control for moving the OPU 330 to an access target spot 600a on the disk surface. In the optical disk device 300, the controller 340 directs a motor driver 310 to drive a spindle motor 320, thereby rotating the optical disk 600.

Hereinafter, a case in which the OPU 330 reads data from the optical disk 600 in the vertical direction (the up-down direction of the plane of paper) (see FIG. 9) is referred to as a case in which the installation direction of the optical disk device 300 is the lateral direction or the optical disk device 300 is installed in the lateral direction. In addition, a case in which the OPU 300 reads data from the optical disk 600 in the horizontal direction (the left-right direction of the plane of paper) is referred to as a case in which the installation direction of the optical disk device 300 is the longitudinal direction or the optical disk device 300 is installed in the longitudinal direction.

The OPU 330 includes a lens which emits a laser beam to a spot 600a and a light receiving unit which receives the laser beam (reflected light) reflected from the disk surface (which are not illustrated), detects the reflected light using the light receiving unit, and reads data recorded on the optical disk 600. The data read by the OPU 330 is output to a host through the controller 340. A read only memory (ROM) 350 stores firmware related to the operation of the optical disk device 300 in advance.

The lens is supported by a wire in the OPU 330. When the installation direction of the optical disk device 300 is the longitudinal direction, the lens supported by the wire is affected by gravity and the angle or position of the optical axis of the lens with respect to the spot 600a deviates, as compared to when the installation direction is the lateral direction. Spherical aberration occurs in the OPU 330 due to the deviation. As a result, the quality of data read from the optical disk 600 deteriorates.

In the optical disk device 300 according to the related art, in order to prevent the influence of the spherical aberration, the operation parameters (servo parameters) of the OPU 330 corresponding to the installation direction of the optical disk device 300 are set in the firmware stored in the ROM 350, considering the angular or positional deviation between the OPU 330 (lens) and the spot 600a. For example, when the optical disk device 300 is longitudinally installed, firmware which includes servo parameters considering the influence of gravity applied to the lens is set in the ROM 350 in advance, for example, when the optical disk device 300 is manufactured. The controller 340 controls the driving of the motor driver 310, the spindle motor 320, and the OPU 330 based on the servo parameters.

The optical disk device 300 does not include a mechanism which determines the installation direction of the optical disk device 300. Therefore, even when the optical disk devices 300 are the same type, the servo parameters of the OPU 330 are different in the optical disk device 300 which is installed in the lateral direction and the optical disk device 300 which is installed in the longitudinal direction, as described above, and different kinds of firmware are stored in the ROM 350. In addition, it is difficult for the user of the optical disk device 300 (information processing apparatus) to set firmware corresponding to the installation direction of the optical disk device 300.

In the related art, a technique has been known in which an optical disk device moves an optical pickup unit in the inner circumferential direction and the outer circumferential direction of an optical disk for a predetermined period of time, detects a change in the mechanical load of a traverse mechanism due to gravity based on the acquired time information, determines a difference between a horizontal position and a vertical position, and changes firmware corresponding to the position based on the determination result of the positions.
[Patent Literature 1] Japanese Laid-open Patent Publication No. 2003-6882

In the above-mentioned information processing apparatus, in some cases, the optical disk device 300 in which firmware for lateral installation is set is longitudinally installed and used in a small PC or the optical disk device 300 in which firmware for longitudinal installation is set is laterally installed and used. In this case, since the settings of the firmware are different from the actual installation direction, the servo parameters of the OPU 330 are not appropriate. Therefore, for example, when the optical disk 600 with low quality is used, a disk error is likely to occur in the reading or writing operation of the optical disk device 300 due to spherical aberration which occurs in the OPU 330.

In addition, in some cases, the optical disk 600 includes an eccentric disk whose gravity center deviates when the disk is molded. As the rotation speed of the eccentric disk in the optical disk device 300 increases, the amount of vibration or noise increases, as compared to a general optical disk 600 with the center aligned with the center of gravity. Therefore, when detecting the eccentric disk, the optical disk device 300 performs a control process of reducing the number of rotations of the spindle motor 320. However, since the servo parameter (for example, a threshold value for reducing the number of rotations) of the spindle motor 320 varies depending on the installation direction of the optical disk device 300, the firmware stored in the ROM 350 varies depending on the installation direction of the optical disk device 300. Therefore, when the optical disk device 300 in which firmware for lateral installation or longitudinal installation is set is used in a direction different from the lateral direction or a direction different from the longitudinal direction (the optical disk device 300 is longitudinally or laterally used), vibration or noise increases. As a result, for example, the number of rotations of the optical disk 600 (spindle motor 320) is reduced.

In recent years, an information processing apparatus having a display integrated therewith has been widely spread in which a housing including the optical disk device 300 is formed integrally with the display. In some cases, the optical disk device 300 is installed in an oblique direction. However, for example, it is preferable that the optical disk device 300 in which firmware for longitudinal installation is set be used in an inclination range of about 15° with respect to a longitudinally installed state, from the servo characteristics of the OPU 330. Similarly, it is preferable that the optical disk device 300 in which firmware for lateral installation is set be used in an inclination range of about 30° with respect to a laterally installed state, from the servo characteristics of the OPU 330. Therefore, when the inclination range of the optical disk device 300 is limited, the inclination range of the display in the information processing apparatus having a display integrated therewith is also limited.

As described above, although the optical disk devices 300 have the same structure, only the firmware varies depending on an installation aspect. Therefore, plural types of optical disk devices 300 that have the same structure and have firmware which varies depending on the installation aspect need to be prepared. Therefore, the management of, for example, manufacture and distribution becomes complicated and costs increase.

As described above, a technique has been known in which an optical disk device moves an optical pickup unit in the inner circumferential direction and the outer circumferential direction of an optical disk for a predetermined period of time, detects a change in the mechanical load of a traverse mechanism due to gravity based on the acquired time information, and determines the difference between a horizontal position and a vertical position. However, since the optical pickup unit is light, the movement distance of the optical pickup unit is short, and the movement speed of the optical pickup unit is high, it is difficult to accurately acquire time information for detecting the position of the optical disk device with high accuracy.

The case in which the optical disk device 300 is provided in the PC has been described above. However, the same problems as described above arise when the optical disk device 300 is provided in various types of apparatuses (information processing apparatus) including AV apparatuses, such as CD/DVD players, home game machines, and PCs.

### SUMMARY

According to an aspect of the embodiments, a medium processing device includes a processor, wherein the processor emits light to a medium by a light source and calculates spherical aberration information relevant to spherical aberration related to the medium based on a detection result of reflected light, determines an installation direction of the medium processing device based on the spherical aberration information, and sets configuration information relevant to an operation for the medium based on a determination result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the structure of an information processing apparatus according to an embodiment.

FIG. 2 is a diagram illustrating an example of the structure of an optical disk device according to this embodiment.

FIGS. 3A and 3B are diagrams illustrating examples of laser beams which are emitted from an OPU to an optical disk when the installation direction of the optical disk device according to this embodiment is a lateral direction and a longitudinal direction, respectively.

FIGS. 4A to 4C are diagrams illustrating the relationship between a light spot and a spherical aberration amount in a light receiving unit according to this embodiment.

FIG. 5 is a diagram illustrating an example of the control of a reading position of an OPU by a driving controller according to this embodiment.

FIG. 6 is a flowchart illustrating an example of a spherical aberration information calculation process of a calculator according to this embodiment.

FIG. 7 is a flowchart illustrating examples of an optical disk device installation direction determination process and a configuration information setting process which are respectively performed by a determination unit and a setting unit according to this embodiment.

FIG. 8 is a diagram illustrating reference spherical aberration information according to a modification of the embodiment.

FIG. 9 is a diagram illustrating an example of the structure of an optical disk device.

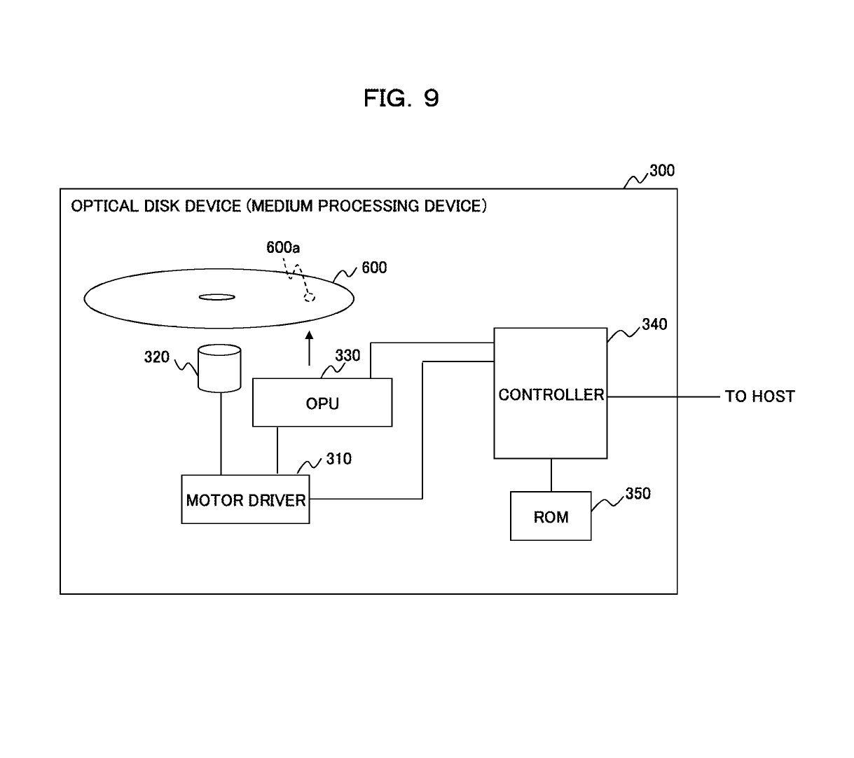

### DESCRIPTION OF EMBODIMENTS

Hereinafter, embodiments will be described with reference to the drawings.

### [1] Embodiment

[1-1] Example of Structure of Information Processing Apparatus

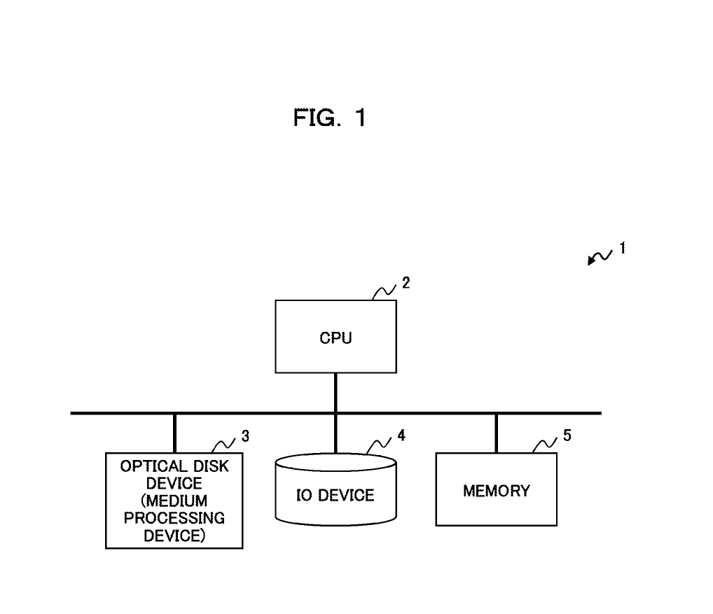

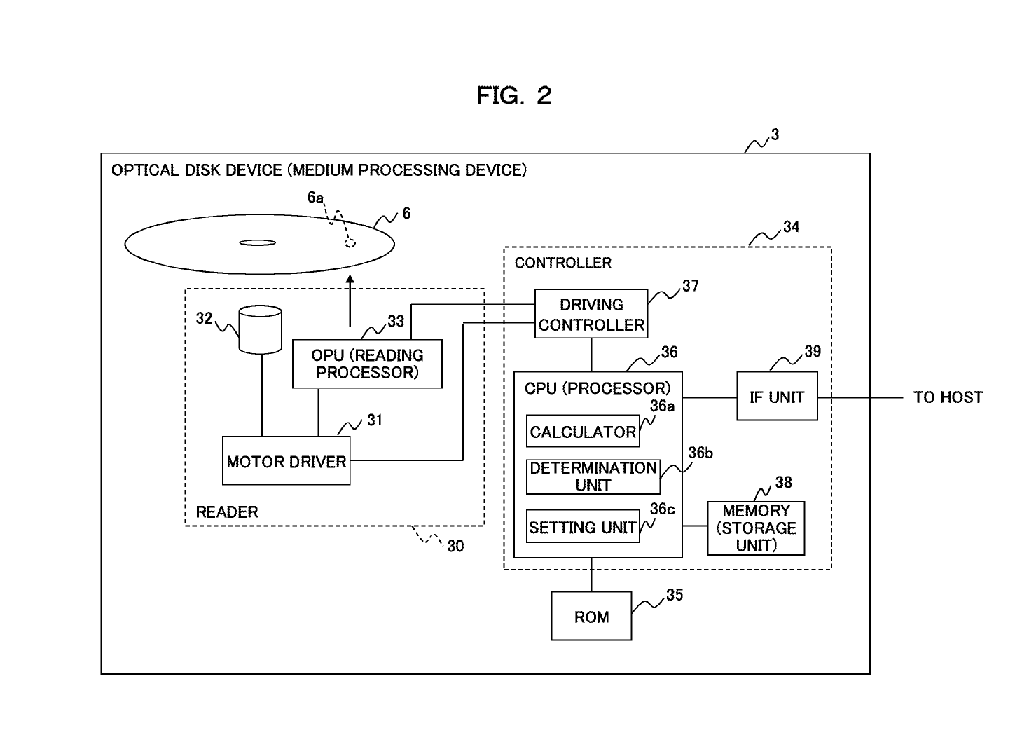

FIG. 1 is a diagram illustrating an example of the structure of an information processing apparatus 1 according to an embodiment and FIG. 2 is a diagram illustrating an example of the structure of an optical disk device 3.

The information processing apparatus 1 is various types of apparatus which can be provided with the optical disk device 3, such as PCs, servers, various types of AV apparatuses including CD players and DVD players, and home game machines.

As illustrated in FIG. 1, the information processing apparatus 1 includes a central processing unit (CPU) 2, the optical disk device 3, an input/output (IO) device 4, and a memory 5.

The CPU 2 is a processing device (processor) which performs various kinds of control or calculation processes, temporarily stores a program stored in, for example, the optical disk device 3, the IO device 4, or a ROM in the memory 5, develops the program, and executes the program to implement various functions.

The CPU 2 according to this embodiment instructs a CPU 36 (see FIG. 2) of the optical disk device 3 to perform a configuration information setting process, which will be described below, to determine the installation direction of the optical disk device 3, and to set configuration information (for example, a servo parameter) corresponding to the determined installation direction.

The IO device 4 is various types of storage devices including a magnetic disk device, such as a hard disk drive (HDD), or a semiconductor drive device, such as a solid state drive (SSD), and is hardware which stores, for example, various kinds of data or programs.

The memory 5 is a storage area which temporarily stores various kinds of data or programs. When executing a program, the CPU 2 temporarily stores data or the program in the memory 5, develops the data or program, and uses the developed data or program. An example of the memory 5 is a volatile memory such as a random access memory (RAM).

The optical disk device (medium processing device) 3 performs predetermined processing for the optical disk (medium) 6 under the control of the CPU 2. For example, the optical disk device 3 acquires data from the optical disk 6 in response to a data acquisition request from the CPU 2 or writes data to the optical disk 6 in response to a data write request from the CPU 2.

The optical disk 6 is a medium-processing-device-readable recording medium, such as a CD (for example, a CD-ROM, a CD-R, or a CD-RW), a DVD (for example, a DVD-ROM, a DVD-RAM, a DVD-R, a DVD+R, a DVD-RW, a DVD+RW, or an HD DVD), a BD (for example, a BD-ROM, a BD-R, or a BD-RE), or a laser disk.

In the optical disk device 3 according to this embodiment, the optical disk is given as an example of the medium to be processed. However, the invention is not limited thereto. For example, a magneto-optical disk from which information can be optically read by an OPU 33, which will be described below, may be used as the medium to be processed by the medium processing device 3. In addition, a cartridge-type medium in which an optical disk or a magneto-optical disk is accommodated or a built-in medium which is provided in the medium processing device 3 may be used as the medium to be processed.

The optical disk device 3 according to this embodiment is installed in various directions, such as a lateral direction, a longitudinal direction, and an oblique inclination, according to the aspect of the information processing apparatus 1. Hereinafter, a case in which the OPU 33 reads information from the optical disk 6 in the vertical direction (the up-down direction of the plane of paper) (see FIG. 2) is referred to as a case in which the installation direction of the optical disk device 3 is the lateral direction (a horizontal direction and a first direction) or the optical disk device 3 is laterally (horizontally) installed. A case in which the OPU 33 reads information in the horizontal direction (the left-right direction of the plane of paper) is referred to as a case in which the installation direction of the optical disk device 3 is the longitudinal direction (a vertical direction and a second direction) or the optical disk device 3 is longitudinally (vertically) installed. A case in which the OPU 33 reads information in the oblique direction is referred to as a case in which the installation direction of the optical disk device 3 is the oblique direction (an inclined direction and a third direction) or the optical disk device 3 is obliquely installed.

As illustrated in FIG. 2, the optical disk device 3 includes a reader 30, a controller 34, and a ROM 35.

The reader 30 reads data (information) from the optical disk 6 and includes a motor driver 31, a spindle motor 32, and the optical pickup unit (OPU) 33.

The motor driver 31 supplies driving power to the spindle motor 32 and the OPU 33 under the control of the controller 34 (driving controller 37).

The spindle motor 32 is supplied with the driving power from the motor driver 31 and rotates the optical disk 6.

The OPU (reading processor) 33 is a unit which emits a laser beam to the surface of the optical disk 6, detects a reflected laser beam (reflected light), and reads data recorded on the optical disk 6. In addition, the OPU 33 is moved to a spot 6a to be accessed by tracking servo control by the controller 34 (driving controller 37) and the motor driver 31 and adjusts a focus on the disk surface using focus servo control.

The ROM 35 stores a plurality of configuration information (servo parameters or firmware) corresponding to the installation direction of the optical disk device 3 in advance and stores reference spherical aberration information, which will be described below, in advance. In this embodiment, the ROM 35 stores configuration information corresponding to the horizontal direction, the vertical direction, and the oblique direction in advance.

In this embodiment, servo parameters of the reader 30 which correspond to each installation direction of the optical disk device 3 and are related to the operations of the spindle motor 32 and the OPU 33 are given as an example of the configuration information. In addition, firmware including servo parameters related to the operation of the reader 30 may be used as the configuration information. Hereinafter, the servo parameters and the firmware are simply referred to as “configuration information”.

The controller 34 controls the optical disk device 3 based on the configuration information stored in the ROM 35 and is, for example, a control large scale integration (LSI). The controller 34 includes a CPU 36, a driving controller 37, a memory 38, and an IF unit 39.

The CPU (processor) 36 directs the driving controller to access the spot 6a, which is an access target of the optical disk 6 and outputs data which has been read through the driving controller 37 to the host, such as the CPU 2, through the IF unit 39 in response to instructions from an external host (for example, the CPU 2) of the optical disk device 3.

When an instruction is input from the CPU 2 through the IF unit 39 or when the optical disk 6 is inserted into the optical disk device 3, the CPU 36 according to this embodiment performs the configuration information setting process, which will be described below, to determine the installation direction of the optical disk device 3 and sets configuration information corresponding to the determined installation direction in the memory 38.

The detailed structure of the CPU 36 will be described below.

The memory (storage unit) 38 stores the configuration information corresponding to the installation direction of the optical disk device 3. A volatile memory, such as a RAM, is given an example of the memory 38.

In this embodiment, the CPU 36 reads the configuration information stored in the memory 38 from the ROM 35 according to the installation direction of the optical disk device 3. However, information indicating the configuration information corresponding to the installation direction among a plurality of configuration information which are stored in the ROM 35 may be used as the configuration information. Hereinafter, these information are simply referred to as configuration information stored in the memory 38.

In addition, the memory 38 stores spherical aberration information calculated by a calculator 36a, which will be described below.

The driving controller 37 is an arithmetic circuit, such as a servo circuit, which performs driving control for the medium, for example, driving control for the reader 30 based on the configuration information stored in the memory 38. Specifically, the driving controller 37 controls the driving of the spindle motor 32 through the motor driver 31 and controls the driving of the OPU 33, using servo parameters which are included in the configuration information corresponding to the installation direction of the optical disk device 3.

The driving controller 37 drives the reader 30 to read data (information) from the optical disk 6 and outputs the data which is read from the optical disk 6 by the OPU 33 to the CPU 36, in response to instructions from the CPU 36.

The IF unit 39 is an interface which is provided between the CPU 36 of the optical disk device 3 and the host of, for example, the CPU 2 in the information processing apparatus 1 and relays data or control signals which are exchanged between the CPU 36 and the CPU 2.

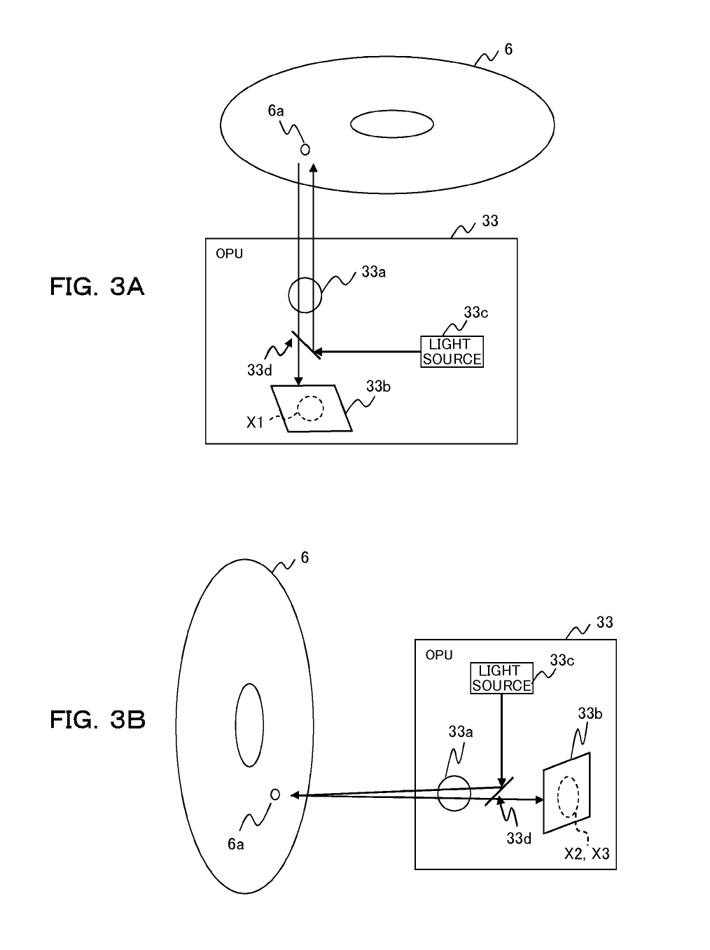

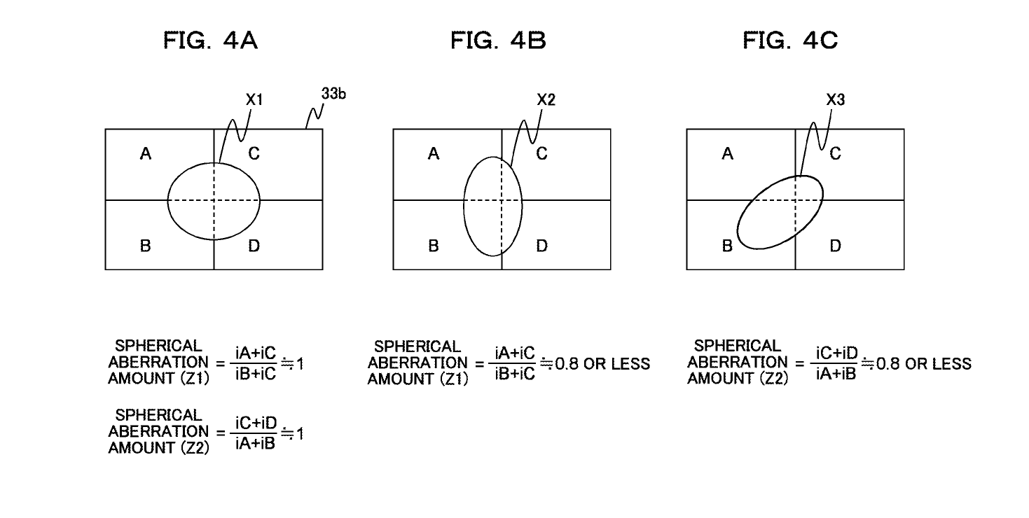

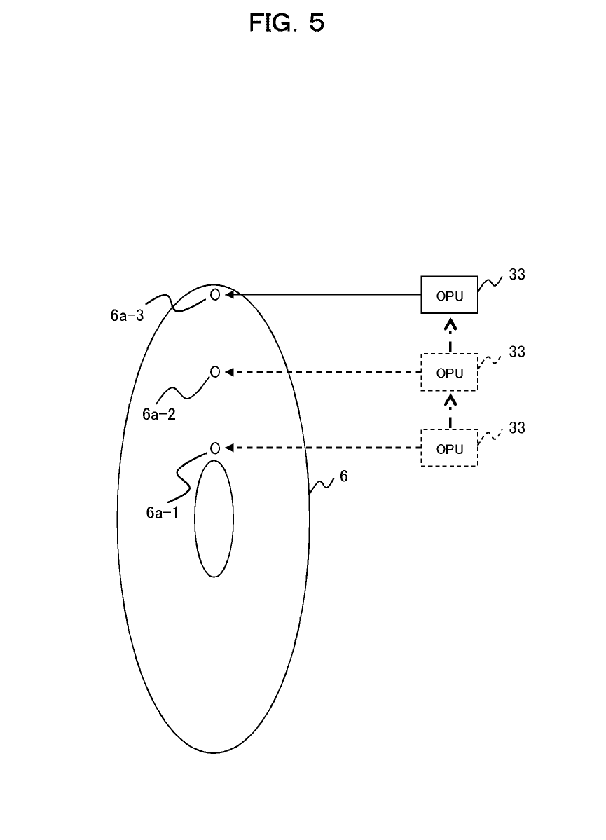

FIGS. 3A and 3B are diagrams illustrating examples of the optical path of the laser beam which is emitted from the OPU 33 to the optical disk 6 when the installation direction of the optical disk device 3 according to this embodiment is the lateral direction and the longitudinal direction, respectively. FIGS. 4A to 4C are diagrams illustrating the relationship between a spherical aberration amount and light spots X1 to X3 in the light receiving unit 33b. FIG. 5 is a diagram illustrating an example of the operation of the driving controller 37 according to this embodiment controlling the reading position of the OPU 33.

In the examples illustrated in FIGS. 3A and 4A, the installation direction of the optical disk device 3 is the lateral direction. In the examples illustrated in FIGS. 3B, 4B, and 4C, the installation direction of the optical disk device 3 is the longitudinal direction.

As illustrated in FIG. 3A, the OPU 33 includes a lens 33a, a light receiving unit 33b, a light source 33c, and a half mirror 33d.

The light source 33c outputs a laser beam to be radiated to the surface of the optical disk 6.

The half mirror 33d reflects the laser beam from the light source 33c to the lens 33a and transmits light reflected from the disk surface to the light receiving unit 33b.

The lens 33a transmits the laser beam from the half mirror 33d to a spot 6a, which is an access target, on the disk surface and transmits light reflected from the spot 6a to the half mirror 33d. In addition, the lens 33a is supported by a wire in the OPU 33.

The light receiving unit 33b receives the reflected light which has been transmitted through the half mirror 33d, includes four photodiodes A to D as illustrated in FIG. 4A, and reads data from the reflected light received by the photodiodes A to D. Specifically, the OPU 33 is configured such that the reflected light is incident on the center of the light receiving unit 33b (photodiodes A to D). Each of the photodiodes A to D in the light receiving unit 33b detects the received reflected light as a current value corresponding to the amount of light which is proportional to a light receiving area and the light receiving unit 33b reads data based on the detected power value. Various known methods can be used as a method of reading data using the light receiving unit 33b and the detailed description thereof will be omitted.

As illustrated in FIGS. 3A and 4A, when the optical disk device 3 is installed in the lateral direction, the light reflected from the optical disk 6 forms a circular light spot X1 at the center of the light receiving unit 33b and the light receiving unit 33b detects an equal current value in the photodiodes A to D.

In contrast, as illustrated in FIGS. 3B, 4B, and 4C, when the optical disk device 3 is installed in the longitudinal direction, as described above, the lens 33a which is supported by the wire is affected by gravity and gets down due to its own weight. Therefore, the angle or position of the optical axis of the lens 33a deviates from the spot 6a on the disk surface. The deviation causes the optical axis of the laser beam from the lens 33a and the optical axis of the light reflected from the disk surface to be inclined (see FIG. 3B). In this case, the light intensity distribution of the reflected light is changed by spherical aberration caused by the inclination of the lens 33a and a light spot X2 or X3 with an elliptical shape which deviates from the center of the light receiving unit 33b is formed (see FIG. 4B or 4C). The light receiving unit 33b detects a current value corresponding to the area distribution of the light spot X2 or X3 in the photodiodes A to D.

That is, when spherical aberration occurs in the optical disk device 3 and the light intensity distribution by the light spot is changed from X1 illustrated in FIG. 4A to X2 illustrated in FIG. 4B or X3 illustrated in FIG. 4C, the distribution of the amount of current in each region of the photodiodes A to D is not uniform.

When the installation direction of the optical disk device 3 is the longitudinal direction, it is determined whether the light spot is in the state X2 or the state X3 in the photodiodes A to D based on the arrangement of the photodiodes A to D in the light receiving unit 33b and the gravity direction.

The medium processing device 3 according to this embodiment automatically determines (detects) its installation direction, based on the spherical aberration of the light spots X1 to X3 of the laser beam in the OPU 33 which corresponds to the installation direction of the medium processing device 3, and sets configuration information (servo parameters or firmware) suitable for the determined installation direction.

The CPU 36 according to this embodiment includes the calculator 36a, a determination unit 36b, and a setting unit 36c.

The calculator 36a emits light to the optical disk 6 and calculates spherical aberration information relevant to spherical aberration related to the optical disk 6 based on the detection result of reflected light, for example, the reading result of the reader 30 (OPU 33). Specifically, the calculator 36a calculates a spherical aberration amount indicating the degree of the spherical aberration which occurs, based on current values iA to iD which are detected by the photodiodes A to D. Various known methods can be used to calculate the spherical aberration amount. In this embodiment, as illustrated in FIGS. 4A to 4C, the calculator 36a calculates the spherical aberration amount using the following Expressions (1) or/and (2).

Spherical aberration amount Z1=(iA+iC)/(iB+iC) [Expression (1)]

Spherical aberration amount Z2=(iC+iD)/(iA+iB) [Expression (2)]

In the expressions, iA to iD indicates current values corresponding to the light receiving areas of light obtained by the photodiodes A to D, respectively.

For example, when the optical disk device 3 is installed in the lateral direction and the circular light spot X1 is formed, both of the spherical aberration amounts Z1 and Z2 are approximate to “1”, as illustrated in FIG. 4A.

In contrast, when the optical disk device 3 is installed in the longitudinal direction, and the elliptical light spot X2 is formed, the spherical aberration amount Z1 is about “0.8” or less, as illustrated in FIG. 4B. Similarly, when the optical disk device 3 is installed in the longitudinal direction, and the elliptical light spot X3 is formed, the spherical aberration amount Z2 is about “0.8” or less, as illustrated in FIG. 4C.

The calculator 36a calculates the spherical aberration amounts as the spherical aberration information and stores the calculated spherical aberration amounts in the memory 38.

The calculator 36a may calculate a tilt correction amount instead of the spherical aberration amount or it may calculate both the spherical aberration amount and the tilt correction amount.

When spherical aberration occurs in the OPU 33 (lens 33a), the quality of data read from the optical disk 6 deteriorates, as described above. When detecting that the current values detected from the photodiodes A to D of the OPU are not equal, the CPU 36 performs tilt correction for correcting the inclination of the lens 33a using the driving controller 37 such that an equal current value is detected from the photodiodes A to D.

The calculator 36a may calculate, as the spherical aberration information, a correction amount (for example, a current value which flows through a coil for adjusting the angle of the lens 33a; the tilt correction amount) related to tilt correction when the spherical aberration amount is zero and store the calculated tilt correction amount in the memory 38. The tilt correction can be performed by various known methods and the detailed description thereof will be omitted.

In the following description, it is assumed that the spherical aberration amount is used as the spherical aberration information.

The calculator 36a can calculate a plurality of spherical aberration information, based on the reading result (detection result) of data from a plurality of different points of the optical disk 6 by the reader 30.

As illustrated in FIG. 5, when receiving an instruction to acquire the spherical aberration information from the CPU 36, the driving controller 37 according to this embodiment directs the reader 30 (OPU 33) to read data from spots 6a-1 to 6a-3 of the optical disk 6 in the radial direction.

For example, the calculator 36a sequentially performs a reading process from an inner circumferential side (6a-1) to an outer circumferential side (6a-3) of the optical disk 6, calculates the spherical aberration information of each spot based on the reading result (detection result) of data at the spots 6a-1 to 6a-3, and stores the calculated plurality of spherical aberration information in the memory 38 so as to be associated with each spot.

The determination unit 36b determines the installation direction of the optical disk device 3 based on the calculated spherical aberration information. Specifically, the determination unit 36b determines whether spherical aberration occurs based on the spherical aberration information calculated by the calculator 36a and determines the installation direction based on whether the spherical aberration occurs.

The setting unit 36c sets configuration information relevant to the operation (for example, the operation of the reader 30) of the optical disk device 3 with respect to the optical disk 6 based on the determination result of the determination unit 36b. Specifically, the setting unit 36c reads configuration information corresponding to the installation direction of the optical disk device 3 which is determined by the determination unit 36b from the ROM 35 and stores the read configuration information in the RAM 38.

The determination unit 36b according to this embodiment can determine whether spherical aberration based on reference spherical aberration information which is calculated in advance according to the installation direction of the optical disk device 3 and the spherical aberration information calculated by the calculator 36a.

In the reference spherical aberration information, the corresponding installation direction (reference installation direction) in each configuration information item stored in the ROM 35 is associated with the spherical aberration information (the spherical aberration amount and/or the tilt correction amount) when the optical disk device 3 is installed in a direction different from the reference installation direction. When the tilt correction amount is used as the spherical aberration information, the reference installation direction is associated with the tilt correction amount of tilt correction for removing the spherical aberration amount when the optical disk device 3 is installed in a direction different from the reference installation direction in the reference spherical aberration information.

The reference spherical aberration information is calculated in advance when the optical disk device 3 is manufactured and is then stored in the ROM 35.

The determination unit 36b uses, as the reference installation direction, an installation direction corresponding to the configuration information which is currently stored in the optical disk device 3 (memory 38) and acquires the spherical aberration information associated with the reference installation direction, with reference to the reference spherical aberration information corresponding to the reference installation direction.

Specifically, if configuration information corresponding to the horizontal direction is set in the optical disk device 3, the determination unit 36b acquires the spherical aberration information associated with the reference installation direction when the optical disk device 3 is installed in the vertical direction different from the horizontal direction, with reference to the reference spherical aberration information in which the reference installation direction is the horizontal direction. If configuration information corresponding to the vertical direction is set in the optical disk device 3, the determination unit 36b acquires the spherical aberration information associated with the reference installation direction when the optical disk device 3 is installed in the horizontal direction different from the vertical direction, with reference to the reference spherical aberration information in which the reference installation direction is the vertical direction. If configuration information corresponding to the oblique direction is set in the optical disk device 3, the determination unit 36b acquires the spherical aberration information associated with the reference installation direction when the optical disk device 3 is installed in the horizontal direction or the vertical direction different from the oblique direction, with reference to the reference spherical aberration information in which the reference installation direction is the oblique direction.

In the following description, it is assumed that the installation direction corresponding to the configuration information set in the optical disk device 3 is the horizontal direction.

The determination unit 36b determines whether the spherical aberration information calculated by the calculator 36a is approximate to the reference spherical aberration information in which the reference installation direction is the horizontal direction. When the spherical aberration information is approximate to the reference spherical aberration information, the determination unit 36b determines that the optical disk device 3 is installed in a direction different from the currently set installation direction and spherical aberration occurs. The determination whether the calculated spherical aberration information is approximate to the reference spherical aberration information may be performed based on, for example, whether the rate of change in the calculated spherical aberration information to the reference spherical aberration information is within a predetermined range (± a few percent). Alternatively, the determination may be performed by other methods.

As such, the determination unit 36b determines whether spherical aberration occurs based on the result of the comparison between the calculated spherical aberration information and the reference spherical aberration information. Therefore, it is possible to easily determine whether spherical aberration occurs.

In some cases, the spherical aberration occurs due to the physical characteristics of the optical disk device 3 (cause; for example, the inclination of the entire optical disk device 3 during manufacture). The spherical aberration caused by the physical characteristics is unique to the optical disk device 3 and is not variable. In this embodiment, the reference spherical aberration is measured in advance during manufacture, such during as an assembly process of the optical disk device 3.

Therefore, the determination unit 36b can determine whether the installation direction of the optical disk device is different from the reference installation direction, based on both the physical characteristics of the optical disk device 3 and the result of the comparison between the reference spherical aberration information and the spherical aberration information calculated by the calculator 36a. Therefore, the reliability of determining the installation direction is improved.

When it is determined that spherical aberration occurs, the determination unit 36b determines whether the spherical aberration information is equal to or less than a predetermined threshold value (for example, about “0.8”).

Then, the determination unit 36b determines the installation direction of the optical disk device 3 from a plurality of directions including the horizontal direction (first direction), the vertical direction (second direction) perpendicular to the horizontal direction, and the oblique direction (third direction) between the horizontal direction and the vertical direction, based on the determination result.

For example, when the installation direction corresponding to the configuration information which is set in the optical disk device 3 is the horizontal direction and it is determined that no spherical aberration occurs based on the spherical aberration information calculated by the calculator 36a and the reference spherical aberration information, the determination unit 36b determines that the optical disk device 3 is installed in the horizontal direction.

In contrast, when it is determined that spherical aberration occurs based on the spherical aberration information and the reference spherical aberration information and the spherical aberration information calculated by the calculator 36a is equal to or less than a predetermined threshold value of “0.8” as illustrated in FIG. 4B or 4C, the determination unit 36b determines that the optical disk device 3 is installed in the vertical direction.

When it is determined that spherical aberration occurs and the spherical aberration information calculated by the calculator 36a is greater than “0.8”, the determination unit 36b determines that the optical disk device 3 is installed in the oblique direction.

As such, when the installation direction corresponding to the configuration information which is set in the optical disk device 3 is the horizontal direction, the determination unit 36b according to this embodiment determines whether the spherical aberration information is equal to or less than the predetermined threshold value (whether the spherical aberration information is greater than the predetermined threshold value in the case of the tilt correction amount), considering that the spherical aberration information (spherical aberration amount) corresponding to the installation direction of the optical disk device 3 is gradually reduced (increased in the case of the tilt correction amount) as the installation direction is changed from the horizontal direction to the oblique direction and from the oblique direction to the vertical direction. In this way, the determination unit 36b determines the installation direction of the optical disk device 3.

When a plurality of spherical aberration information are calculated by the calculator 36a, the determination unit 36b may determine the installation direction of the optical disk device 3 based on the plurality of spherical aberration information. In this case, the determination unit 36b can determine whether the optical disk 6 is deformed based on the plurality of spherical aberration information.

The spherical aberration also occurs due to the deformation, such as warping, of the optical disk 6. The laser beam emitted from the OPU 33 is not vertical to the disk surface due to the deformation, such as warping, of the optical disk 6, and light reflected from the disk surface is not vertically incident on the light receiving unit 33b of the OPU 33. As a result, spherical aberration occurs. In addition, the degree of warping of the optical disk 6 increases from the inner circumferential side to the outer circumferential side of the optical disk 6 in the radial direction.

Therefore, the spherical aberration amount caused by the deformation, such as warping, of the optical disk 6, decreases from the inner circumferential side to the outer circumferential side and the tilt correction amount increases from the inner circumferential side to the outer circumferential side.

When the calculator 36a calculates spherical aberration information at an inner circumferential position (an inner circumferential portion and the spot 6a-1), an intermediate position (an intermediate portion and the spot 6a-2), and an outer circumferential position (an outer circumferential portion and the spot 6a-3) of the optical disk in the radial direction, the determination unit 36b according to this embodiment determines the installation direction of the optical disk device 3 based on first spherical aberration information for the inner circumferential portion 6a-1 in which the influence of the warping of the optical disk 6 is small.

Then, the determination unit 36b compares the first spherical aberration information for the inner circumferential portion 6a-1 with second spherical aberration information for the intermediate portion 6a-2 or the outer circumferential portion 6a-3 which is closer to the outer circumferential side of the optical disk 6 in the radial direction than the inner circumferential portion 6a-1. When it is determined that the rate of change in the second spherical aberration information to the first spherical aberration information is within a predetermined range (for example, about “±10%”), the determination unit 36b determines that deformation, such as warping, does not occur in the optical disk 6. On the other hand, when it is determined that the rate of change is beyond the predetermined range, the determination unit 36b determines that deformation, such as warping, occurs in the outer circumference of the optical disk 6.

When the determination unit 36b determines that the outer circumference of the optical disk 6 is deformed, it may store the rate of change in the second spherical aberration information to the first spherical aberration information in the memory 38.

That is, as described above, the determination unit 36b can detect whether the deformation, such as warping, of the optical disk 6 occurs and detect the degree of deformation, based on the spherical aberration information at a plurality of points of the optical disk 6. When it is determined that the outer circumference of the optical disk 6 is deformed, the driving controller 37 may perform correction, which corresponds to the access position of the reader 30 to the optical disk 6 in the radial direction, for the configuration information for controlling the driving of the reader 30, based on the rate of change stored in the memory 38, and control the driving of the reader 30 based on the corrected configuration information. In this way, the driving controller 37 can control the driving of the reader 30, using appropriate servo parameters which follow the deformation of the outer circumference of the optical disk 6, based on the rate of change stored in the memory 38.

The configuration information setting process performed by the calculator 36a, the determination unit 36b, and the setting unit 36c may be performed whenever the optical disk 6 is inserted into the optical disk device 3 or it may be performed by, for example, the user when an instruction to perform the process is input from the host device (CPU 2) of the optical disk device 3, for example, when the information processing apparatus 1 (optical disk device 3) is newly used or when the installation environment of the information processing apparatus 1 is changed.

[1-2] Example of Operation of Optical Disk Device

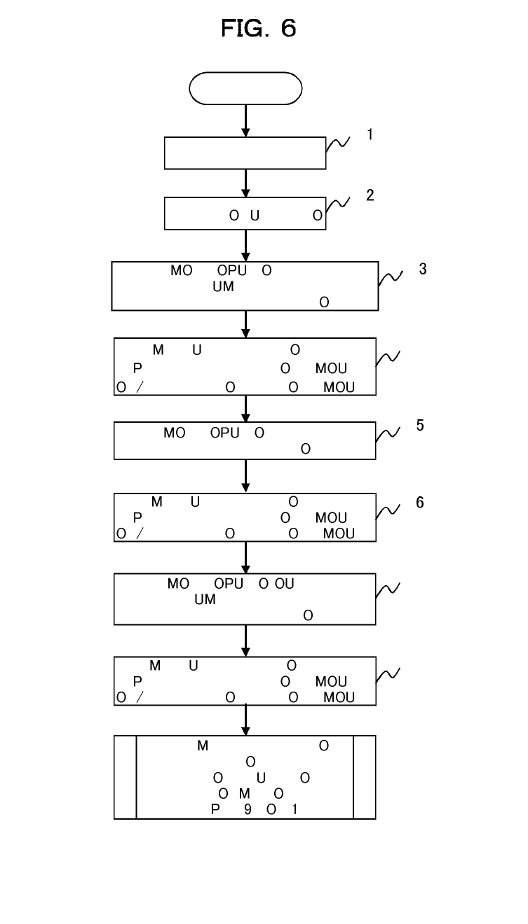

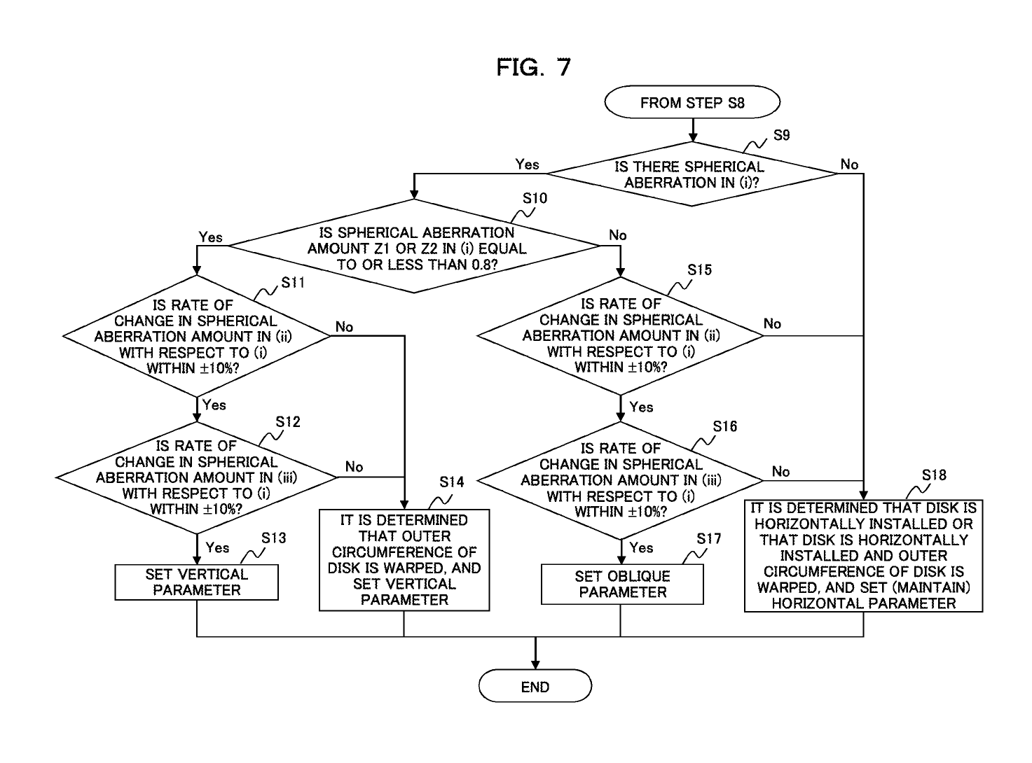

Next, an example of the configuration information setting process of the optical disk device 3 according to this embodiment having the above-mentioned structure will be described with reference to FIGS. 6 and 7.

FIG. 6 is a flowchart illustrating an example of a spherical aberration information calculation process performed by the calculator 36a according to this embodiment and FIG. 7 is a flowchart illustrating an example of the process of the determination unit 36b determining the installation direction of the optical disk device 3 and the configuration information setting process of the setting unit 36c.

In the following description, similarly to the above description, it is assumed that the installation direction corresponding to the configuration information set in the optical disk device 3 is the horizontal direction (first direction).

As illustrated in FIG. 6, when the optical disk 6 is inserted into the optical disk device 3, with an instruction to perform the setting process being input from the host (Step S1), the driving controller 37 starts focus servo control for the OPU 33 to adjust the focus (Step S2).

Then, the driving controller 37 controls the driving of the reader 30 and the OPU 33 is moved to the spot 6a-1 which is disposed on the inner circumferential side of the optical disk 6 in the radial direction (Step S3). Then, the calculator 36a emits light to the optical disk 6, calculates spherical aberration information (for example, a spherical aberration amount Z1 or Z2) (i) based on the detection result of reflected light, that is, data which is read from the spot 6a-1 by the reader 30, and stores the spherical aberration information (i) in the memory 38 (Step S4).

Then, the driving controller 37 moves the OPU 33 to the intermediate spot 6a-2 of the optical disk 6 in the radial direction (Step S5). Then, the calculator 36a calculates spherical aberration information (ii) based on data which is read from the spot 6a-2 by the reader 30, and stores the spherical aberration information (ii) in the memory 38 (Step S6).

The driving controller 37 moves the OPU 33 to the spot 6a-3 which is disposed on the outer circumferential side of the optical disk 6 in the radial direction (Step S7). Then, the calculator 36a calculates spherical aberration information (iii) based on data which is read from the spot 6a-3 by the reader 30 and stores the spherical aberration information (iii) in the memory 38 (Step S8).

Then, the CPU 36 determines the installation direction of the optical disk device 3 and sets the configuration information in Steps S9 to S18 illustrated in FIG. 7.

Specifically, as illustrated in FIG. 7, the determination unit 36b determines whether spherical aberration occurs based on the spherical aberration information (i) which is stored in the memory 38 in Step S4 and the reference spherical aberration information (Step S9).

When it is determined in Step S9 that spherical aberration occurs (a Yes route in Step S9), the determination unit 36b determines whether the first spherical aberration information (i) is equal to or less than a predetermined threshold value, for example, whether the spherical aberration amount Z1 or Z2 is equal to or less than “0.8” (Step S10).

When it is determined that the spherical aberration information (i) is equal to or less than the predetermined threshold value (a Yes route in Step S10), for example, when the spherical aberration amount Z1 or Z2 in the spherical aberration information (i) is “0.7”, the determination unit 36b determines that the installation direction of the optical disk device 3 is the vertical direction (second direction). In addition, the determination unit 36b determines whether the rate of change in the spherical aberration information (ii) to the spherical aberration information (i) is within a predetermined range (for example, ±10%) (Step S11).

When it is determined that the rate of change in the spherical aberration information (ii) to the spherical aberration information (i) is within the predetermined range (a Yes route in Step S11), for example, when the spherical aberration amount Z1 or Z2 in the spherical aberration information (ii) is “0.68” and the rate of change is about “−3%”, the determination unit 36b determines whether the rate of change in spherical aberration information (iii) to the spherical aberration information (i) is within a predetermined range (for example, ±10%) (Step S12).

When it is determined that the rate of change in spherical aberration information (iii) to the spherical aberration information (i) is within the predetermined range (a Yes route in Step S12), for example, when the spherical aberration amount Z1 or Z2 in the spherical aberration information (iii) is “0.65” and the rate of change is about “−7%”, the determination unit 36b determines that the installation direction of the optical disk device 3 is the vertical direction and deformation, such as warping, does not occur in the optical disk 6. Then, the setting unit 36c sets configuration information corresponding to the vertical direction in the memory 38 (Step S13). Then, the process ends.

On the other hand, when it is determined in Step S11 or S12 that the rate of change in the spherical aberration information (ii) or (iii) to the spherical aberration information (i) is beyond the predetermined range (a No route in Step S11 or S12), for example, when the spherical aberration amount Z1 or Z2 in the spherical aberration information (iii) is “0.6” and the rate of change is about “−14”, the determination unit 36b determines that the installation direction of the optical disk device 3 is the vertical direction and deformation, such as warping, occurs in the outer circumference of the optical disk 6. Then, the setting unit 36c sets configuration information corresponding to the vertical direction in the memory 38 (Step S14). Then, the process ends. In this case, as described above, the determination unit 36b may store the rates of change in the spherical aberration information (ii) and the spherical aberration information (iii) to the spherical aberration information (i) in the memory 38 and the driving controller 37 may correct the operation parameters of the reader 30 based on the rates of change.

When it is determined in Step S10 that the spherical aberration information (i) is greater than the predetermined threshold value (a No route in Step S10), for example, when the spherical aberration amount Z1 or Z2 in the spherical aberration information (i) is “0.9”, it is determined whether the rates of change in the spherical aberration information (ii) and the spherical aberration information (iii) to the spherical aberration information (i) are within a predetermined range (for example, ±10%) (Steps S15 and S16).

When it is determined that the rates of change in the spherical aberration information (ii) and the spherical aberration information (iii) to the spherical aberration information (i) are within the predetermined range (Yes routes in Steps S15 and S16), the determination unit 36b determines that the installation direction of the optical disk device 3 is the oblique direction and deformation, such as warping, does not occur in the optical disk 6. Then, the setting unit 36c sets configuration information corresponding to the oblique direction in the memory 38 (Step S17). Then, the process ends.

On the other hand, when it is determined in Step S15 or S16 that the rate of change in the spherical aberration information (ii) or (iii) to the spherical aberration information (i) is beyond the predetermined range (a No route in Step S15 or S16), the determination unit 36b determines that the installation direction of the optical disk device 3 is the horizontal direction and deformation, such as warping, occurs in the outer circumference of the optical disk 6. In this case, the determination unit 36b determines that the small spherical aberration detected in Step S9 is caused by the deformation of the optical disk 6. Then, the setting unit 36c sets configuration information corresponding to the horizontal direction in the memory 38 (maintains the current configuration information) (Step S18). Then, the process ends.

In the case of the No route in Step S15 or S16, the determination unit 36b may determine that the spherical aberration detected in Step S9 is caused by the optical disk device 3 installed in the oblique direction and deformation, such as warping, occurs in the outer circumference of the optical disk 6. In this case, the setting unit 36c sets configuration information corresponding to the oblique direction in the memory 38.

When it is determined in Step S9 that spherical aberration does not occur (a No route in Step S9), the determination unit 36b determines that the installation direction of the optical disk device 3 is the horizontal direction. Then, the setting unit 36c sets configuration information corresponding to the horizontal direction in the memory 38 (maintains the current configuration information) (Step S18). Then, the process ends. In this case, similarly to Steps S11 and S12, the determination unit 36b may determine whether warping occurs in the optical disk 6.

In the above-mentioned process, the CPU 36 determines the installation direction of the optical disk device 3 and sets configuration information corresponding to the installation direction.

When the installation direction corresponding to the configuration information set in the optical disk device 3 is the vertical direction (second direction), a servo parameter for forming the light spot X1 in a circular shape when the optical disk device 3 is installed in the vertical direction is set in the memory 38. Therefore, in this case, when the occurrence of spherical aberration is not detected in Step S9, the determination unit 36b determines that the installation direction of the optical disk device 3 is the vertical direction and the setting unit 36c sets configuration information corresponding to the vertical direction in Step S18 (maintains the current configuration information). On the other hand, when the occurrence of spherical aberration is detected in Step S9 and it is determined in Step S10 that the spherical aberration information (i) is equal to or less than the predetermined threshold value, the determination unit 36b determines that the installation direction is the horizontal direction and the setting unit 36c sets configuration information corresponding to the horizontal direction in Step S13 or S14.

In FIGS. 6 and 7, the spherical aberration amounts Z1 and Z2 are used as the spherical aberration information. However, the invention is not limited thereto. The tilt correction amount may be used together with or instead of the spherical aberration amount. When the tilt correction amount is used as the spherical aberration information, the tilt correction amount increases as the spherical aberration amount decreases. Therefore, the determination unit 36b determines whether the spherical aberration information (i) is greater than the predetermined threshold value in Step S10.

As such, according to the optical disk device 3 of this embodiment, the calculator 36a emits light to the optical disk 6 and calculates spherical aberration information relevant to spherical aberration related to the optical disk 6 based on the detection result of reflected light. In addition, the determination unit 36b determines the installation direction of the optical disk device 3 based on the spherical aberration information and the setting unit 36c sets configuration information relevant to an operation for the optical disk 6 based on the determination result of the determination unit 36b. Therefore, when the optical disk device 3 is provided in, for example, the information processing apparatus 1, it is possible to set appropriate configuration information (servo parameter) for longitudinal installation, oblique installation, or lateral installation, based on the determination result of the installation direction of the optical disk device 3. For example, even when the optical disk 6 with low quality is used, it is possible to prevent a disk error in the reading and writing operations of the optical disk device 3. In addition, even when an eccentric disk is used, it is possible to prevent the occurrence of an event, such as an increase in vibration or nose or a reduction in the number of rotations of the optical disk 6 (spindle motor 32).

In addition, a servo parameter suitable for oblique installation may be stored as the configuration information in advance. In this case, even when the optical disk device 3 is installed at a tilt angle (for example, 15 degrees or more with reference to the vertical direction or 30 degrees or more with reference to the horizontal direction) which is not covered by the configuration information relevant to longitudinal installation or lateral installation, it is possible to set appropriate configuration information based on the determination result of the determination unit 36b. Therefore, it is possible to lift restrictions in the installation direction of the optical disk device 3 and to flexibly respond to various installation directions of the optical disk device 3.

The optical disk device 3 according to this embodiment can automatically detect its own installation direction and appropriately change the configuration information. Therefore, it is not necessary to manufacture plural types of optical disk devices 3 in which different configuration information are set depending on the installation direction and only the optical disk device 3 in which one kind of configuration information (for example, configuration information suitable for lateral installation) is set in advance may be manufactured. As a result, it is easy to manage manufacture and distribution and it is possible to prevent an increase in costs.

According to the optical disk device 3 of this embodiment, the installation direction is determined based on the spherical aberration information. Therefore, it is possible to accurately determine the installation direction of the optical disk device 3, as compared to a method of detecting a change in a mechanical load applied to a traverse mechanism by gravity.

The calculator 36a, the determination unit 36b, and the setting unit 36c operate at least one of when the optical disk 6 is inserted into the optical disk device 3 and when an instruction to perform a process is input from the host device (CPU 2) of the optical disk device 3. Therefore, it is possible to set configuration information suitable for the installation direction whenever the installation direction of the optical disk device 3 is changed. As a result, for example, the user can arbitrarily install the optical disk device 3, without recognizing the installation direction of the optical disk device 3 and convenience is improved.

The calculator 36a calculates the spherical aberration information a plurality of times from the inner circumferential portion 6a-1 to the outer circumferential portion 6a-3 of the optical disk 6 in the radial direction. Then, the determination unit 36b determines whether the outer circumference of the optical disk 6 is deformed based on the spherical aberration information which is calculated at a plurality of points. Therefore, it is possible to accurately determine the installation direction of the optical disk device 3, considering the influence of the deformation, such as warping, of the optical disk 6.

[1-3] Modifications

The determination unit 36b according to the above-described embodiment uses the reference spherical aberration information to determine whether spherical aberration occurs in the optical disk device 3. However, the invention is not limited thereto.

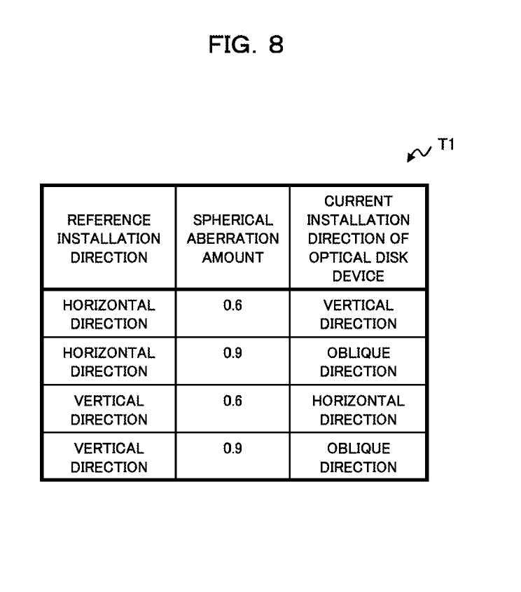

FIG. 8 is a diagram illustrating reference spherical aberration information according to a modification of the embodiment.

For example, a determination unit 36b according to the modification of the embodiment may determine the installation direction of the optical disk device 3 based on a table T1 illustrated in FIG. 8 and the spherical aberration information calculated by the calculator 36a.

The table T1 indicates reference spherical aberration information according to this modification. Similarly to the above-described embodiment, the table T1 is measured in advance when the optical disk device 3 is manufactured and is stored in the ROM 35. In the table T1, the direction (reference installation direction) set in the optical disk device 3, spherical aberration information (in the example illustrated in FIG. 8, a spherical aberration amount) when the optical disk device 3 is installed in another installation direction, and the (another) installation direction are associated with each other.

The determination unit 36b according to this modification searches for reference spherical aberration information which is approximate to the spherical aberration information calculated by the calculator 36a from the reference spherical aberration information corresponding to the installation directions set in the optical disk device 3. Then, when the reference spherical aberration information which is approximate to the calculated spherical aberration information is searched for, the determination unit 36b sets the installation direction (another installation direction) corresponding to the searched reference spherical aberration information as the installation direction of the optical disk device 3.

Therefore, the determination unit 36b can determine the installation direction of the optical disk device 3 based on both the result of the comparison between the spherical aberration which occurs due to a difference in the installation direction calculated by the calculator 36a and the reference spherical aberration information and the physical characteristics of the optical disk device 3. As a result, reliability is improved.

The optical disk device 3 can perform the process of the determination unit 36b determining the installation direction of the optical disk device 3 based on the table T1, instead of the process in Steps S9 and S10 of FIG. 7.

Therefore, according to the optical disk device 3 of this modification, the same effect as that in the above-described embodiment is obtained and it is possible to easily determine the installation direction of the optical disk device 3, as compared to the optical disk device 3 according to the above-described embodiment.

### [2] Others

The preferred embodiment of the invention has been described above. However, the invention is not limited to the above-mentioned specific embodiment and modifications, but various changes and modifications of the invention can be made without departing from the scope and spirit of the invention.

For example, the calculator 36a calculates three spherical aberration information from the inner circumferential side to the outer circumferential side of the optical disk 6 in the radial direction. However, the calculator 36a may calculate spherical aberration information relevant to two different points, or three or more different points of the optical disk 6. When the deformation, such as warping, of the optical disk 6 is not needed, the calculator 36a may calculate spherical aberration information relevant to an arbitrary point of the optical disk 6.

In the above-described embodiment, the calculator 36a calculates the spherical aberration information on the reading result (detection result) of data from the optical disk 6 by the OPU 33. However, the invention is not limited thereto. For example, another unit which detects the spherical aberration may be provided instead of the OPU 33 and the calculator 36a may calculate the spherical aberration information based on the reading result (detection result) of data by this unit.

In the above-described embodiment, the light receiving unit 33b of the OPU 33 includes four photodiodes A to D. However, the invention is not limited thereto. The light receiving unit 33b may include an arbitrary number of photodiodes as long as it can detect the spherical aberration information and other light receiving elements may be used instead of the photodiode.

The predetermined threshold value in Step S10 and the predetermined range in Steps S11, S12, S15, and S16 in FIG. 7 are not limited to the above-mentioned value and range. The predetermined threshold value and the predetermined range may be arbitrarily set depending on the relationship between the installation direction of the optical disk device 3 and the spherical aberration information (the spherical aberration amount or the tilt correction amount).

In the reference spherical aberration information according to the above-described embodiment, the reference installation direction is associated with the spherical aberration information when the optical disk device 3 is installed in a direction different from the reference installation direction. However, the invention is not limited thereto.

For example, in the reference spherical aberration information, the reference installation direction may be associated with the spherical aberration information when the optical disk device 3 is installed in the reference installation direction. In this case, the reference spherical aberration information indicates spherical aberration information which is generated by the physical characteristics of the optical disk device 3 for each reference installation direction. In this case, the determination unit 36b can determine that no spherical aberration occurs when the spherical aberration information calculated by the calculator 36a is approximate to the corresponding reference spherical aberration information and can determine that spherical aberration occurs when the calculated spherical aberration information is not approximate to the corresponding reference spherical aberration information. The process of determining whether spherical aberration occurs based on the reference spherical aberration information may be performed in Step S9 of FIG. 7.

A program (configuration information setting program) for implementing the functions of the CPU 36 (the calculator 36a, the determination unit 36b, and the setting unit 36c) and the driving controller 37 is recorded on a computer-readable recording medium, such as a flexible disk, CD (for example, a CD-ROM, a CD-R, or a CD-RW), a DVD (for example, a DVD-ROM, a DVD-RAM, a DVD-R, a DVD+R, a DVD-RW, a DVD+RW, or an HD DVD), a Blu-ray disc, a magnetic disk, an optical disk, or a magneto-optical disk and is then provided. A computer reads the program from the recording medium, transmits the read program to an internal storage device or an external storage device, stores the program in the storage device, and uses the program. In addition, the program may be recorded on a storage device (recording medium), such as a magnetic disk, an optical disk, or a magneto-optical disk, and then provided from the storage device to the computer through a communication.

When the functions of the CPU 36 (the calculator 36a, the determination unit 36b, and the setting unit 36c) and the driving controller 37 are implemented, the program stored in the internal storage device (in this embodiment, the ROM 35 or the memory 38) is executed by a microprocessor (in this embodiment, the CPU 36) of the computer. In this case, the computer may read the program recorded on the recording medium and execute the program. When the functions of the calculator 36a, the determination unit 36b, the setting unit 36c, and the driving controller 37 are implemented, a program which is stored in a storage device of an external setting node may be executed by the microprocessor (in this embodiment, for example, the CPU 36) of the computer.

In this embodiment, the concept of the computer includes hardware and an operating system and the computer means hardware which operates under the control of the operating system. When the operating system is not needed and hardware is operated only by an application program, the hardware corresponds to the computer. The hardware includes at least a microprocessor, such as a CPU, and a means for reading the computer program recorded on the recording medium. In this embodiment, the optical disk device 3 has the functions of the computer.

In relation to the embodiments and the modification described above, the following iterative decoding method and apparatus are disclosed: an installation orientation detection device including a processor, wherein the processor emits light to a medium by a light source and calculates spherical aberration information relevant to spherical aberration related to the medium based on a detection result of reflected light, and determines an installation direction of the medium processing device based on the spherical aberration information.

According to the embodiments and the modification, it is possible to provide a medium processing device whose installation direction is not limited.

In addition, according to the embodiments and the modification, it is possible to detect the installation direction of the medium processing device with high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A medium processing device comprising:
a processor, wherein
the processor
emits light to a medium by a light source and calculates spherical aberration information relevant to spherical aberration related to the medium based on a detection result of reflected light,
determines an installation direction of the medium processing device based on the spherical aberration information, and
sets configuration information relevant to an operation for the medium based on a determination result.

2. The medium processing device according to claim 1, wherein
the processor determines whether the spherical aberration occurs based on the calculated spherical aberration information and determines the installation direction based on whether the spherical aberration occurs.

3. The medium processing device according to claim 2, wherein
the processor determines whether the spherical aberration occurs, based on reference spherical aberration information corresponding to the installation direction of the medium processing device which is calculated in advance and the calculated spherical aberration information.

4. The medium processing device according to claim 3, wherein
in the reference spherical aberration information, the spherical aberration information when the medium processing device is installed in an installation direction different from a reference installation direction is associated with each reference installation direction, and
the processor uses, as the reference installation direction, an installation direction corresponding to the configuration information which is currently set, acquires the spherical aberration information associated with the reference installation direction with reference to the reference spherical aberration information corresponding to the reference installation direction, determines whether the calculated spherical aberration information is approximate to the acquired spherical aberration information, and determines that the spherical aberration occurs when it is determined that the calculated spherical aberration information is approximate to the acquired spherical aberration information.

5. The medium processing device according to claim 3, wherein
in the reference spherical aberration information, the reference installation direction, the spherical aberration information when the medium processing device is installed in an installation direction different from the reference installation direction, and the different installation direction are associated with each other, and
the processor uses, as the reference installation direction, an installation direction corresponding to the configuration information which is currently set, searches for reference spherical aberration information approximate to the calculated spherical aberration information from the reference spherical aberration information corresponding to the reference installation direction, and determines the different installation direction corresponding to the searched reference spherical aberration information as the installation direction of the medium processing device when the reference spherical aberration information approximate to the calculated spherical aberration information is searched for.

6. The medium processing device according to claim 1, wherein
the processor
calculates a plurality of spherical aberration information based on the detection result of the medium at a plurality of different positions and
determines the installation direction based on the plurality of spherical aberration information.

7. The medium processing device according to claim 6, wherein
the processor
determines the installation direction from a plurality of directions including a first direction, a second direction perpendicular to the first direction, and a third direction between the first direction and the second direction, based on first spherical aberration information relevant to an inner circumferential position of the medium in a radial direction and second spherical aberration information relevant to an outer circumferential position of the medium in the radial direction.

8. The medium processing device according to claim 7, wherein
the processor determines whether the spherical aberration occurs based on the first spherical aberration information,
when the spherical aberration occurs, the processor determines whether the first spherical aberration information is equal to or less than a predetermined threshold value, and
the processor determines the installation direction from the plurality of directions including the first to third directions based on the determination result.

9. The medium processing device according to claim 7, wherein
the processor determines whether the medium is deformed based on the first spherical aberration information and the second spherical aberration information.

10. The medium processing device according to claim 9, wherein
the processor determines that the medium is not deformed when it is determined that a rate of change in the second spherical aberration information with respect to the first spherical aberration information is within a predetermined range, and determines that the outer circumference of the medium is deformed when it is determined that the rate of change is beyond the predetermined range.

11. The medium processing device according to claim 10, further comprising:
a storage unit that stores the configuration information set by the processor and stores the rate of change in the second spherical aberration information with respect to the first spherical aberration information; and
a driving controller that controls the driving of the medium based on the configuration information stored in the storage unit, corrects the configuration information according to an access position of the medium in the radial direction, based on the rate of change stored in the storage unit when the processor determines that the outer circumference of the medium is deformed, and controls the driving of the medium based on the corrected configuration information.

12. The medium processing device according to claim 1, further comprising:
a storage unit that stores the configuration information set by the processor; and
a driving controller that controls the driving of the medium based on the configuration information stored in the storage unit.

13. The medium processing device according to claim 1, wherein
the spherical aberration information is at least one of a spherical aberration amount which varies depending on the installation direction of the medium processing device and a tilt correction amount when tilt correction is performed for the spherical aberration amount and the spherical aberration amount becomes zero.

14. The medium processing device according to claim 1, wherein
the processor performs a process when the medium is inserted into the medium processing device or when a host device of the medium processing device inputs an instruction to perform the process to the medium processing device.

15. A method of setting configuration information relevant to an operation of a medium processing device for a medium, the medium processing device includes a processor and reads information from the medium, the method comprising:
emitting light to the medium by a light source and calculating spherical aberration information relevant to spherical aberration related to the medium based on a detection result of reflected light by the processor;
determining an installation direction of the medium processing device based on the calculated spherical aberration information by the processor; and
setting the configuration information based on the determination result of the installation direction by the processor.

16. The method of setting configuration information according to claim 15, wherein
determining whether the spherical aberration occurs based on the calculated spherical aberration information, and determining the installation direction based on whether the spherical aberration occurs.

17. The method of setting configuration information according to claim 16, wherein
determining whether the spherical aberration occurs, based on reference spherical aberration information corresponding to the installation direction of the medium processing device which is calculated in advance and the calculated spherical aberration information.

18. The method of setting configuration information according to claim 15, wherein
calculating a plurality of spherical aberration information based on the detection result of the medium at a plurality of different positions, and
determining the installation direction based on the plurality of spherical aberration information.

19. A computer-readable recording medium having stored therein a configuration information setting program for causing a computer serving as a medium processing device to execute a process for reading information from a medium, the process comprising:
emitting light to the medium by a light source and calculating spherical aberration information relevant to spherical aberration related to the medium based on a detection result of reflected light;
determining an installation direction of the medium processing device based on the calculated spherical aberration information; and
setting configuration information relevant to an operation for the medium based on the determination result of the installation direction.
